(19) United States
(12) Patent Application Publication
(10) Pub. No.: US 2002/0152153 A1
(43) Pub. Date: Oct. 17, 2002

(54) Securities trading system, computer system, buy/sell order placement method, buy/sell order processing method, and program

(75) Inventor: Toru Nakagawa, Machida-shi (JP)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY (US)

(21) Appl. No.: 10/112,514

(22) Filed: Mar. 28, 2002

(30) Foreign Application Priority Data
Apr. 12, 2001 (JP) 2001-114643

(51) Int. Cl. G06F 17/60

(52) U.S. Cl. 705/37

(57) ABSTRACT

A securities trading system including a customer's PC 30 connected to the Internet 10, a securities company's site 20 which is connected to the Internet 10 and processes securities trading orders from the customer's PC 30, and an exchange's computer 50 connected to the securities company's site 20 via a leased line 40, wherein the securities company's site 20 provides information of a group order entry screen for entering an order covering multiple issues and their respective limit prices specified as a group, to the customer's PC 30, and after displaying the group order entry screen information provided by the securities company's site 20 in a browser 31, the customer's PC 30 outputs a group order covering a group of issues for which respective limit prices are specified, through the Internet 10.

### DETAILED DESCRIPTION OF THE INVENTION

1. Field of the Invention

The present invention relates to a securities trading system which handles buy/sell orders for securities and more particularly to a securities trading system which enables group limit orders.

2. Background Art

Recently, along with the globalization of networks as typified by the Internet, commercial transactions have been carried out widely on networks. In particular, net brokers (online brokers) have appeared that deal in stocks through “B-to-C” or business-to-consumer commercial transactions on the Internet. Various financial institutions, firms, manufacturers, etc. are entering the market in addition to existing securities companies, resulting in active Net trading. The deregulation of stock commissions, in particular, has made it possible to offer discounts on commissions. Thus, an environment has been created for trading securities readily by making use of the Internet's advantages such as convenience in information gathering and reduced transaction costs.

In the present state of securities trading such as stock trading, orders for several issues are processed concurrently and independently of one another. Consequently, if a customer puts in orders for multiple issues, the trade may be executed for two or more issues. Since customers normally have limited purchase funds, execution of two or more orders will cause a shortage of settlement funds. Therefore, as things stand now, a customer must put in an order by narrowing the choice down to one issue.

### PROBLEMS TO BE SOLVED BY THE INVENTION

On the other hand, customers normally specify a target (so-called “limit price”) at which they will buy a particular issue.

Generally, there are two or more desired issues for a customer.

In some cases, customers want to buy Net-related stocks, bank stocks, or the like in large sums. Considering the turnover of funds, customers often want to buy any issue if it reaches or falls below its limit price. However, it sometimes happens, for example, that a customer puts in an order for company A's issue, but its limit price is not reached and instead company B's issue for which the customer did not put in an order reaches its limit price. In such a case, the customer misses an important business chance, resulting in a great loss.

This also causes the securities company to miss a business opportunity and suffer a revenue loss due to the failure to earn commissions. Forecasts of stock price trends are provided in the form of advice to customers to help select issues. However, it is not possible to use limit orders for multiple issues for business purposes because a forecast will cause trouble if it turns out to be wrong although it will earn reputation if it proves right.

The present invention has been made to solve the above problems.

One of its objects is to improve the opportunity of executing limit orders for multiple issues desired by the customer in securities trading to the extent that payment can be made.

Another object is to increase customers and commission income by introducing new services.

Still another object is to make it possible to produce profit margins in a short period.

### SUMMARY OF THE INVENTION

To achieve the above objects, the present invention provides a buy/sell order placement method for placing buy/sell orders for securities with a securities company, computer system, etc. which define a group consisting of multiple issues with their respective limit prices specified and ensure that when one or more issues in the defined group reach their specified limit prices on the securities market, the securities company will place the order for only one issue. Specifically, the present invention provides a securities trading system comprising a customer's computer connected to a network and a brokerage firm's computer system which is connected to the network and processes securities trading orders from the customer's computer, wherein the brokerage firm's computer system provides information of a group order entry screen for entering an order covering multiple issues and respective limit prices of the issues specified as a group, to the customer's computer through the network, and after displaying the group order entry screen information provided by the brokerage firm's computer system in a browser, the customer's computer outputs a group order covering a group of issues for which respective limit prices are specified, through the network.

Preferably the group order entry screen provided by the brokerage firm's computer system includes specification of closed option processing that permits to buy and sell issues in the group freely by specifying a period (closed period) during which placement of a liquidation order from the customer is prohibited. This will allow the brokerage firm to earn profit margins in a short period.

The brokerage firm's computer system may output information on order execution for one of the issues of the group order. The output includes display output in brokerage firm's computer system in addition to output to the customer's computer via e-mail or the like.

Besides, buy/sell orders for a particular issue in the group order may be sent from the brokerage firm's computer system to a securities exchange's computer through a predetermined line.

Incidentally, the term “securities” here includes not only negotiable securities such as stocks and bonds, but also commodities, options, etc. The same applies hereinafter.

Also, a “computer system” may consist of one or more computers regardless of whether the computers are housed separately or what type of network they employ.

Furthermore, the present invention provides a computer system for processing securities trading orders from a customer, comprising group order receiving means for receiving a group order for a group of issues for which respective limit prices are specified; and output means for outputting information on order execution for one of the issues of the received group order if the trade is executed for that issue at the specified limit price.

The computer system further comprises limit order output means for outputting a limit order for a particular issue among the issues of the group order received by the group order receiving means, by estimating expected values of all the issues.

Viewed from another angle, the computer system installed at securities companies and the like to which the present invention is applied comprises group order screen providing means for providing, to a customer's computer, a group order screen for the customer to put in a buy/sell order by specifying a group of issues and respective limit prices of the issues; order receiving means for receiving a group order from the customer based on the group order screen provided by the group order screen providing means; and buy/sell order output means for outputting a market order or limit order for each of the given issues of the group order received from the order receiving means.

On the other hand, the present invention provides a buy/sell order placement method for placing buy/sell orders for securities with a brokerage firm through a network, the method comprising the steps of: sending, through the network, group order entry screen information for specifying multiple issues and their respective limit prices of the issues as a group; and receiving, through the network, order information including multiple issues, limit prices of the issues, and a validity period of the group order entered by a customer based on the group order entry screen information.

Also, the buy/sell order processing method to which the present invention is applied comprises the steps of: receiving a group order including multiple issues and respective limit prices of the issues specified as a group; estimating expected values of all the issues of the received group order; and putting in a limit order for the issue with the highest expected value. In addition, the method further comprises the steps of: determining whether market prices satisfy the limit prices for the issues of the group; and putting in market orders for the issues for which the market prices satisfy the limit prices.

Viewed from still another angle, the buy/sell order processing method to which the present invention is applied comprises the steps of: accepting specification of closed option processing that permits to get profit margins by specifying a closed period during which placement of a liquidation order from the customer is prohibited along with a group order including multiple issues and specified respective limit prices of the issues as a group; determining whether the present profit is estimated to be larger than future profit according to a profit estimation function; and executing the trade of the issues which are estimated to give larger profits at present than in the future. Regarding the execution of the trade, the method sells at the market the issue which has already been bought, and buys at the market one of the other issues that will maximize profit.

Besides, the present invention provides a computer program product comprising a computer usable medium having computer readable program code means embodied in said medium, for implementing designated functions in a computer, said computer program product comprising: a computer readable program code means for causing the computer to receive, through a network, a group order consisting of multiple issues and their limit prices specified on an order entry screen; a computer readable program means for causing the computer to decide on the issue for which a buy/sell order should be placed out of the issues of the group, based on the group order received through the network; and a computer readable program means for causing the computer to sell at the market the issue which has already been bought, and buy at the market one of the other issues that will maximize profit if the present profit is estimated to be larger than future profit according to a profit estimation function, in a closed period during which placement of a liquidation order from the customer is prohibited.

Incidentally, the computer programs may be provided, for example, from a remote program-transmission device, for example, to the securities exchange's computer system via the network. The program-transmission device may comprise storage means such as a CD-ROM, DVD, memory, or hard disk for storing the programs, and transmission means for transmitting the programs via connector or a network such as the Internet or a LAN to a computer system or the like that executes the program by reading it from the storage means. Also, the computer programs may be provided directly on a storage medium such as a CD-ROM or DVD. In that case, the computer such as a PC on which the programs are installed needs only to be provided with a capability (CD-ROM drive, DVD drive, or the like) to read the storage medium.

### PREFERRED EMBODIMENT

The present invention will be described in detail below with reference to the embodiments illustrated in the accompanying drawings.

FIG. 1 is a diagram illustrating the configuration of the securities trading system according to this embodiment. In this embodiment, the Internet 10, which is a network, is connected with a brokerage firm's site 20—a computer system of a brokerage firm such as a securities company—as well as with a customer's PC (personal computer) 30. The securities company's site 20, i.e., the brokerage firm's computer system, comprises a Web server 21 which provides, for example, a home page of the securities company or brokerage firm and supplies order screen information to the customer's PC 30 as it is accessed by the customer's PC 30; an order processing server 22 for receiving orders from the customer's PC 30 and processing them; and an order DB (database) 23 for storing order information from the customer. Incidentally, an order screen information may be supplied to the customer's PC 30 by the order processing server 22. Also, the Web server 21 and order processing server 22 may be implemented in the same physical computer device (server). On the other hand, the functions of the Web server 21 or order processing server 22 may be implemented by two or more servers.

The customer's PC 30 is provided with a browser 31, i.e., software for browsing the home page provided by the Web server 21, displaying an order screen, and outputting input information resulting from the customer's requests to the securities company's site 20. The order processing server 22 at the securities company's site 20, which is the computer system of the securities company (brokerage firm), is connected to the internet 10 to receive orders from the customer's PC 30 as well as to an exchange's computer 50 (such as a computer of a stock exchange or commodity exchange) via a leased line 40. The order processing server 22 places limit orders with the exchange's computer 50 via the leased line 40. Various group order information received by the order processing server 22 from a customer is stored in the order DB 23 and used during order processing or closed option processing (described later) performed by the order processing server 22. If an order is executed as a result of processing at the securities company's site 20, the issue and price associated with the given order are output to the customer's PC 30 using the output means such as an e-mail via the internet 10, for example. This information is also output for display on a computer device at the securities company's site 20.

FIG. 2 shows an example of the order entry screen 70 provided by the securities company's site 20 and displayed on the customer's PC 30. The order entry screen 70 displayed in the browser 31 contains a group order entry screen 71 which allows a multiple issues to be specified, Buy/Sell entry 72 for specifying “Sell” or “Buy,” Limit Price Validity Period entry 73 for specifying the validity period of a group order, Closed Option entry 74 for specifying whether to use a closed option (described later), Closed Period specification 75 for specifying the closed period for the closed option, Order entry 76, and Cancel entry 77. The Buy/Sell entry 72 and Closed Option entry 74 may be implemented, for example, as radio buttons while the Limit Price Validity Period entry 73 and Closed Period specification 75 may be implemented, for example, as pull-down menus. Incidentally, the order entry screen 70 is configured such that all the necessary entries can be completed on a single page. However, it is also possible configure it such that a group order will be completed on multiple pages, or on other input screens with different contents as well by accessing them via other URLs.

Now description will be given about how to implement the securities trading system according to this embodiment. FIG. 3 shows a first example of how to implement it. As shown in FIG. 3, the customer specifies limit prices and quantities, for example, for three issues on the browser 31 via the internet 10, for example, according to the order entry screen 70 shown in FIG. 2. Upon receiving the group order, the order processing server 22 of the securities company's site 20 selects the one issue whose limit price is most likely to be reached, based on order information, the current market prices of stocks, data on past price movements, and experience. Then it places a limit order with the exchange's computer 50 of the securities market via the leased line 40. In the example of FIG. 3, an order is placed for 1,000 shares of company A at a limit price of 3,000 yen. The term “limit price” here means the price set in a trading order: normally, to “buy at 1,000 yen” means to buy a given item if it falls to 1,000 yen or lower while to “sell at 1,500” means to sell a given item if it reaches or exceeds 1,500 yen.

In the example of FIG. 3, if the issue of company A lowers to 3,000 yen or less, a buy transaction is executed without any problems. However, it may not lower to 3,000 yen easily. On the other hand, it happens that the issue of company B has lowered below 1,520 yen and is approaching 1,500 yen, the limit price set by the customer. Consequently, the order processing server 22 of the securities company's site 20 cancels the buy order for company A according to the criteria described later and places a limit order for 2,000 shares of company B at a limit price of 1,500 yen. Later when company B's stock hits the limit price of 1,500 yen, the buy transaction is executed, resulting in the execution of the customer's order for company B with the securities company. As a result, the securities company earns commission income from the customer without any practical loss.

In this way, the securities company's site 20 regularly watches stock prices and assesses prospects concerning all specified issues even after a first limit order is placed until a limit price specified by the customer is reached. If prospects change, the securities company's site 20 cancels the previous order and places a new limit order for the most prospective issue with the exchange's computer 50 of the securities market.

FIG. 4 shows a second example of how to implement the securities trading system. Suppose, for example, a group order for three issues is put in, as is the case with the example of FIG. 3. Upon receiving the group order, the securities company's site 20 places a limit order for 1,000 shares of company A at a limit price of 3,000 with the exchange's computer 50 via the order processing server 22, similarly to the example of FIG. 3. The securities company's site 20 watches the stock market and when company C's stock reaches the limit price of 1,000 yen set by the customer, it buys 3,000 shares of company C's stock at the market. Suppose the stock price rises and the shares are actually bought at 1,010. On the other hand, with respect to the customer, the securities company executes the order for 3,000 shares of company C's stock at 1,000 yen, and thus loses 30,000 yen in the example of FIG. 4. The term “at the market” here refers to a market order which is placed by specifying an issue, quantity, etc., but without specifying a price.

In cases such as the example of FIG. 4, if a forecast by the securities company turns out to be wrong and the limit price of an issue other than the issue for which an order has been placed is reached first, the system according to this embodiment cancels the ordered issue and buys at the market the issue which reaches its limit price. The buy price available for this market order may exceeds the limit price set in the group order from the customer. In that case, the risk is borne by the securities company, i.e., any loss is covered by the securities company.

Now the closed option processing will be described. The closed option processing involves setting a closed period during which a liquidation order from a customer is prohibited after a limit order from the customer is executed. In other words, it permits the securities company to get profit margins. The term “liquidation” here means to sell what has been bought or buy back what has been sold. When the user selects the closed option and specifies a closed period on the order entry screen 70 shown in FIG. 2 using the customer's PC 30, the order processing server 22 of the securities company's site 20 performs the closed option processing.

FIG. 5 illustrates the closed option processing taking as an example the stock price movements of company B and company C. In the figure, the horizontal axis represents time and the vertical axis represents price. The limit prices specified by the customer are 1,500 yen for company B and 1,000 for company C. It is assumed that the order processing server 22 of the securities company's site 20 has placed a limit order to buy company C at 1,000 yen. In the example of FIG. 5, after a certain period of time, the stock price of company C falls below 1,000 yen and a buy transaction is executed at 1,000 yen.

In closed option processing, the securities company's site 20 continues to keep track of specified stocks during the closed period even after a buy transaction is executed. In Case 1 shown in FIG. 5, the stock price (1,050 yen) of company C is higher than the buy price (1,000 yen) and the difference between them is calculated. Then the difference between the stock price (1,520 yen) and the limit price (1,500 yen) of company B is calculated and the two differences are compared. In this case, since company C's price difference is larger than company B's price difference, the order processing server 22 liquidates company C's shares and places a buy order for company B with the exchange's computer 50.

In Case 1 shown in FIG. 5, even if the securities company compensates for company B's price difference, it can still get a profit margin of 110,000 yen as a result of the liquidation of company C's shares. In Case 2, liquidation of company C's shares produces a profit margin of 90,000 yen. In this way, the securities company can repeat operations of earning profit margins any number of times during a closed period.

The targets of profit margins and the timings of buying or selling are determined by the securities company on its own responsibility. This provides a great opportunity to earn profits without risks. The profit margins earned can be divided, for example, according to arrangements between the customer and the securities company. Also, if a closed period is provided, it is desirable to return profits to the customer by, for example, reducing the commission.

Now detailed description will be given about the flow of processes performed automatically by the order processing server 22—a computer system—of the securities company's site 20. The following describes “buy” orders by giving examples, but the description similarly applies to “sell” orders although a greater-than sign will be replaced by a less-than sign when making judgments.

FIG. 6 is a flowchart showing the overall process flow of the order processing server 22. First the order processing server 22 performs an order receiving process (Step 101) of receiving an order from a customer via the Internet 10 based on the operation of the Order entry 76 in the order entry screen 70 (shown in FIG. 2) on the customer's PC 30. Then the order processing server 22 places an order with the exchange's computer 50 via the leased line 40 (Step 102).

Then the order processing server 22 determines whether the order has been executed (Step 103). If the order has been executed, the order processing server 22 determines whether the closed option is specified (Step 104). If it is specified, the order processing server 22 performs closed option processing (Step 105) and then performs a reporting process (Step 106) and ends the flow of processing. If it is found in Step 104 that the closed option is not specified, the order processing server 22 performs a reporting process (Step 106) immediately and ends the flow of processing.

In the reporting process, the order processing server 22 informs the customer's PC 30 about the execution of the order by means of e-mail or the like, for example, via the Internet 10. Also, information about the execution of the order is displayed in a display section of the order processing server 22.

If it is found in Step 103 that the order has not been executed, the order processing server 22 determines whether the limit prices are still valid (Step 107). If the validity period of the limit prices specified by the user has expired, the order processing server 22 performs a reporting process (Step 106) and ends the flow of processing. If the limit prices are still valid, the order processing server 22 makes inquiries to the exchange's computer 50, for example, by calling periodically using a timer to obtain price information (Step 108), and then returns to Step 102 to continue order processing.

FIGS. 7 and 8 are flowcharts which describe in detail the order processing of Step 102 shown in FIG. 6. As shown in FIG. 7, the order processing server 22 estimates expected values of all the issues composing the received group order (Step 201). As the expected values for limit prices being realized in the future, this embodiment adopts the estimation function expressed as:

fₙ=f(n, s, r)

where

n: issue ID within group

s: limit price

r: current market price

Step 201 in FIG. 7 shows the estimation function from f₁ (n=1, s=s₁, R=r₁) to fₘ (n=m, s=sₘ, r=rₘ),

where:

m: number of issues

A simple example of an estimation function may be the reciprocal of the difference between the current market price and limit price. It can be expressed, for example, as follows:

f=r/(r−s), where (r≠s)

The order processing server 22 performs order processing, based on the estimation function. In the example of the above function, it can be determined that the limit price has been reached if, for example,

r=s, or f<0

Returning to FIG. 7, the order processing server 22 determines whether an order has already been placed with the exchange's computer 50 (Step 202). If an order has been placed, the order processing server 22 goes to the flow (2) shown in FIG. 8. If an order has not been placed yet, the order processing server 22 determines whether there is an issue which satisfies the relationship rᵢ≦sᵢ, i.e., whether there is an issue whose current market value is equal to or lower than its limit price (Step 203).

If there is, the order processing server 22 places a market order for the issue i (Step 204). The order processing server 22 enters “i” as N, the ID of the issue for which a buy order has been placed (Step 205), and goes to Step 103 in FIG. 6. If it is found in Step 203 that there is no issue whose current market value is equal to or lower than its limit price, the order processing server 22 places a market order for the issue n =max (Step 206). It is assumed that the expected value of the limit price given by the estimation function fₙ is the highest for fₘₐₓ, i.e., when n=max. Then the order processing server 22 substitutes “max” for N as the ID (Step 207) and goes to Step 103 in FIG. 6.

If it is found in Step 202 that an order has already been placed, the order processing server 22 goes to the flow (2) shown in FIG. 8. First, the order processing server 22 determines whether there is an issue which satisfies the relationship rᵢ≦sᵢ (Step 211). If there is, the order processing server 22 cancels the buy order for N and places a market order for issue i (Step 212). Then, the order processing server 22 substitutes “i” for N (Step 213) and goes to Step 103 in FIG. 6. If it is found in Step 211 that there is no issue which satisfies the relationship rᵢ≦sᵢ, the order processing server 22 determines whether N=max (Step 214). If N=max, the order processing server 22 goes to Step 103 in FIG. 6. If it is not that N=max, the order processing server 22 cancels the buy order for N and places a market order for the issue n=max (Step 215). Then the order processing server 22 substitutes “max” for N (Step 216) and goes to Step 103 in FIG. 6.

FIG. 9 is a flowchart describing, in detail, the closed option processing performed in Step 105 in FIG. 6. In the closed option processing, the order processing server 22 determines first whether now is a closed period (Step 301). If now is not a closed period, the order processing server 22 does not perform a closed option process and goes to Step 106 in FIG. 6 where it performs a reporting process.

If now is a closed period, the order processing server 22 determines (Step 302) whether G (i, j)>0, where:

G (i, j): current profit estimation function

i: already bought issue

j: issue that maximizes profit among other issues

If it is not G (i, j)>0, the order processing server 22 makes inquiries to the exchange's computer 50 (Step 303), and then returns to Step 301. If it is found in Step 302 that G (i, j)>0, the order processing server 22 determines (Step 304) whether G (i, j)−H (i, j)>0, where

H (i, j): future profit estimation function

If

r: current value at the market

k: purchase price for an executed transaction

s: limit price

l: expected future price

Then the above functions can be expressed as follows:

G(i, j)=(rᵢ−kᵢ)−(rⱼ−sⱼ)

H(i, j)=(lᵢ−kᵢ)−(lⱼ−sⱼ)

where (rᵢ−kᵢ) and (lᵢ−kᵢ) are final profits from liquidation while (rⱼ−sⱼ) and (lⱼ−sⱼ) are losses incurred by changing issues.

If it is found in Step 304 that G (i, j)−H (i, j)>0 is not satisfied, the order processing server 22 goes to Step 303 and then returns to Step 301. If G (i, j)−H (i, j)>0, the order processing server 22 sells issue i at the market (liquidation) and buys issue j at the market (Step 305). The order processing server 22 waits for the buy order for issue j to be executed (Step 306), replaces i with “j” (Step 307), goes to Step 303, and then returns to Step 301.

Possible methods for price forecasting include regression analysis and data mining, but know-how of the securities company will be relied on instead of correlations between data because short-term stock prices are affected largely by unexpected, incidental events or habitual behavior.

Although the flowchart shown in FIGS. 6 to 7 describes processes of actually executing buy orders in Steps 204, 206, 215, 212, etc., it is also possible to provide the processes according to this embodiment in the form of a computer program only to the extent of deciding issues to buy or sell and outputting them to a display or the like and leave it up to, for example, employees of the brokerage firm such as a securities company to execute the trade finally. Preferably, a buy or sell transaction should be executed formally only after a human operator gives approval (confirmation), for example, by pressing a Buy or Sell button.

As described in detail above, in securities trading as typified by stock trading, this embodiment allows the customer on the side of the customer's PC 30 to maximize the chances of executing a limit order among a plurality of desired issues to the extent that payment can be made. The addition of the closed option creates a possibility of receiving a share of profit margins in a short period. This is practically equivalent to entrusting a securities company with daily trading free of charge.

On the other hand, brokerage firms such as securities companies can expect to expand their customer bases with the introduction of the new service. Even on the level of a single customer, they can expect increased commission income thanks to the increased possibility of orders being executed. Furthermore, forecasting techniques of stock price movements are expected to lead directly to income and the closed option provides an opportunity to earn profits without risks.

Now, regarding the idea about commissions, basically commissions should be set higher than those for single issue orders to cover the risks of the securities company. Also, if the closed option is added, since it provides an opportunity to earn profits without risks, the profits may be deducted from the commission or a predetermined share of the profits may be given to the customer. Commissions may be set, for example, as follows:

For a group of three issues without any closed period: 30% higher than the commission for a single issue order.

For a group of five issues with a closed period of one day (that day only): equal to (or 20% less than) the commission for a single issue order.

For a group of five issues with a closed period of one day (that day only): 50% higher than a single issue order and with 75% of the profit from liquidation within the closed period being returned to the customer.

Incidentally, this embodiment is not limited to stock trading: it can apply to trading of not only negotiable securities such as stocks and bonds, but also commodities, options, etc. They are generically referred to herein as “securities.”

### ADVANTAGES OF THE INVENTION

As described above, the present invention can improve the opportunity of executing limit orders for multiple issues desired by the customer in securities trading to the extent that payment can be made.

### BRIEF DESCRIPTION OF THE DRAWINGS

FIG. 1 is a diagram illustrating the configuration of the securities trading system according to this embodiment;

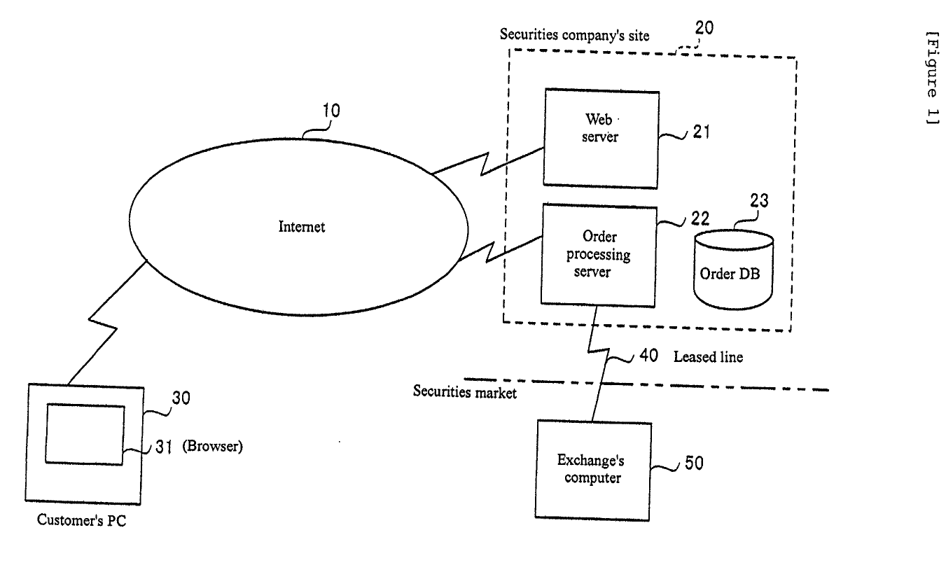

FIG. 2 is a diagram showing an example of an order entry screen provided by a securities company's site and displayed on a customer's PC;

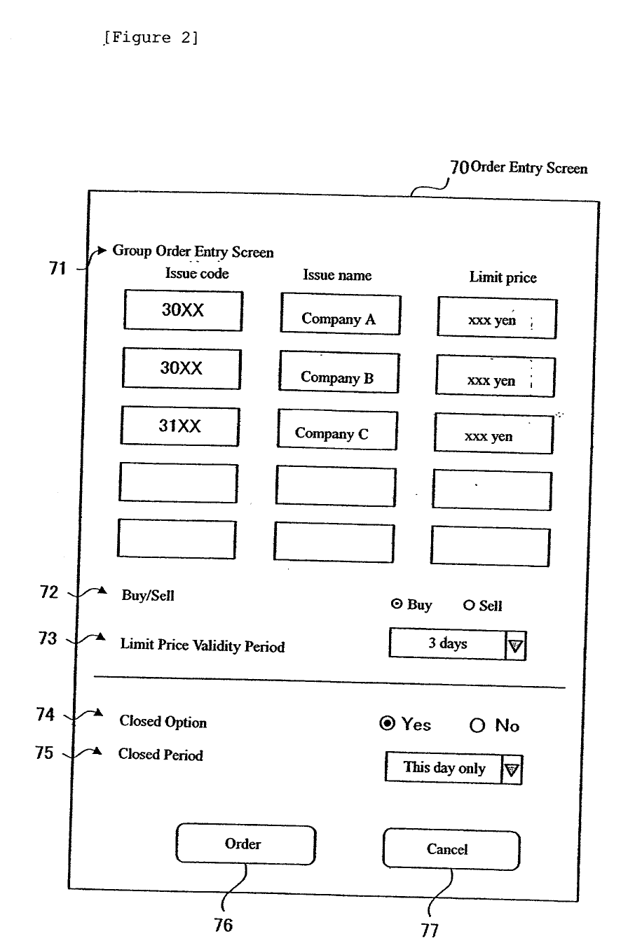

FIG. 3 is a diagram showing a first example of how to implement the securities trading system;

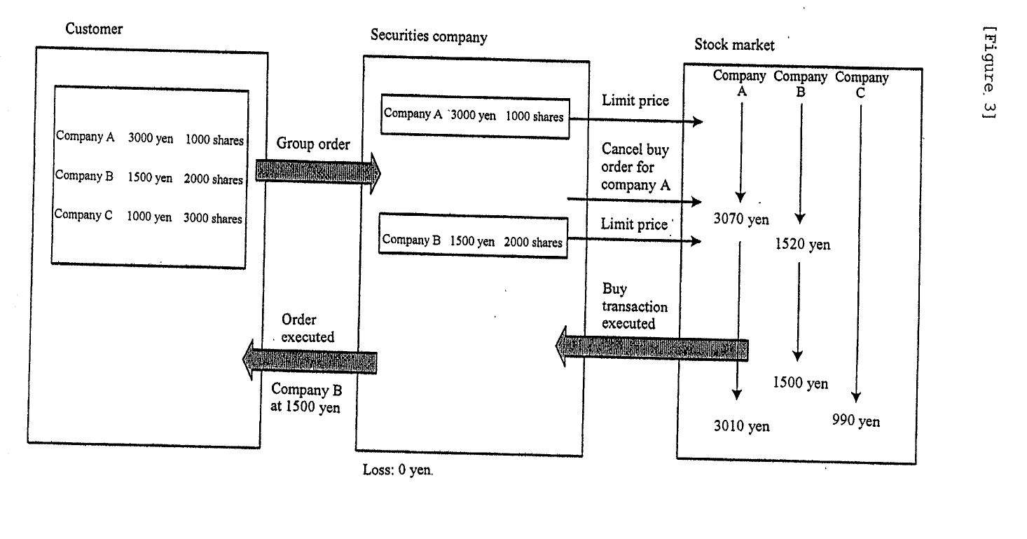

FIG. 4 is a diagram showing a second example of how to implement the securities trading system;

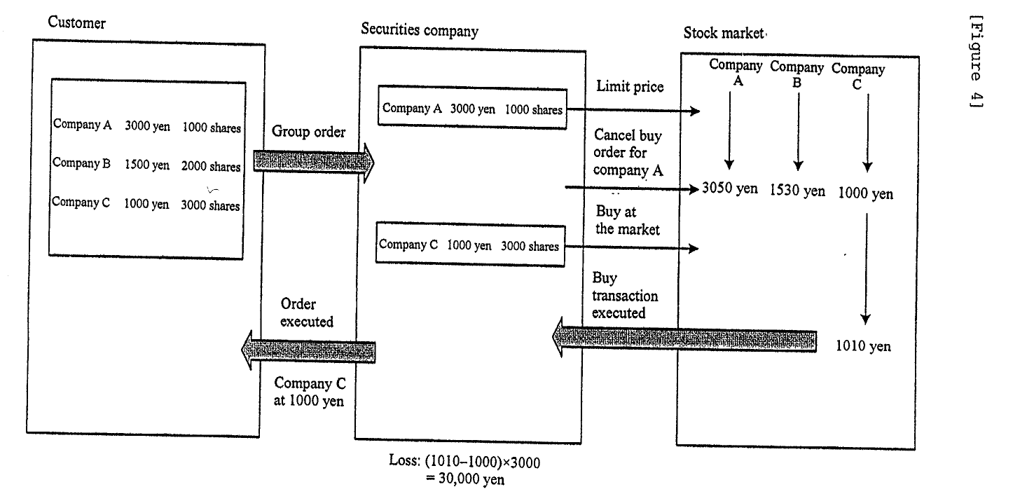

FIG. 5 is a diagram illustrating closed option processing;

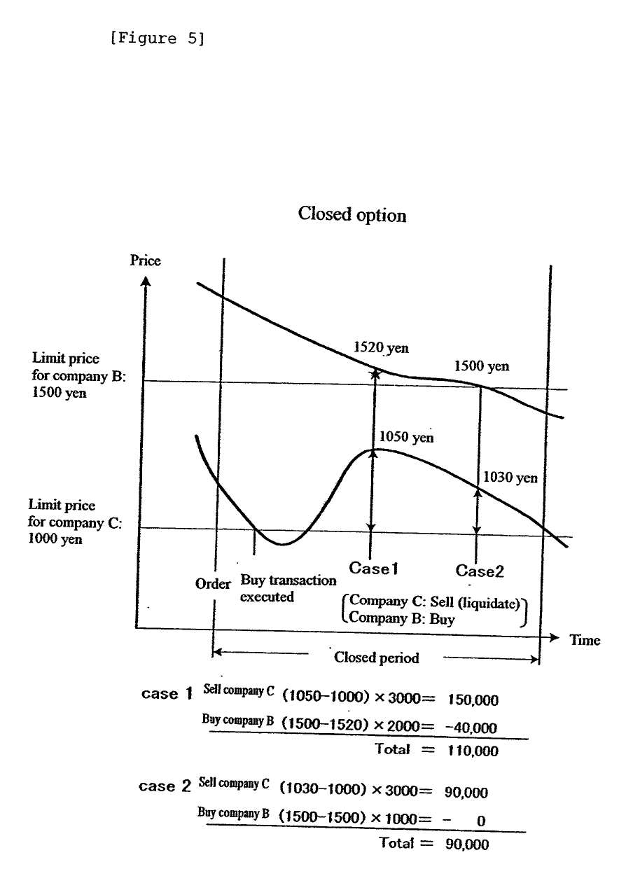

FIG. 6 is a flowchart showing the overall process flow of an order processing server;

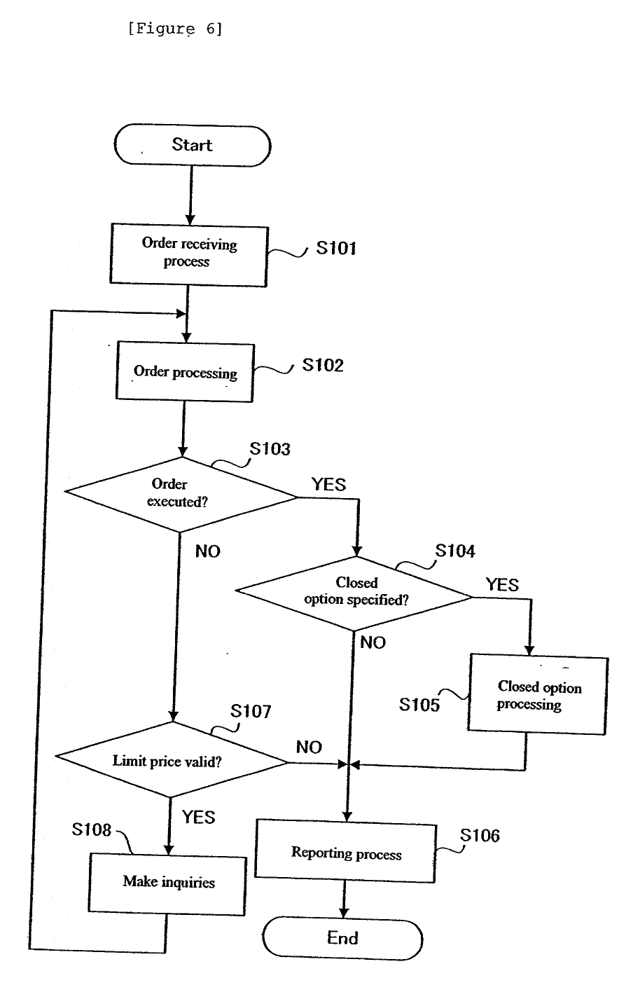

FIG. 7 is a flowchart describing, in detail, the order processing shown in FIG. 6;

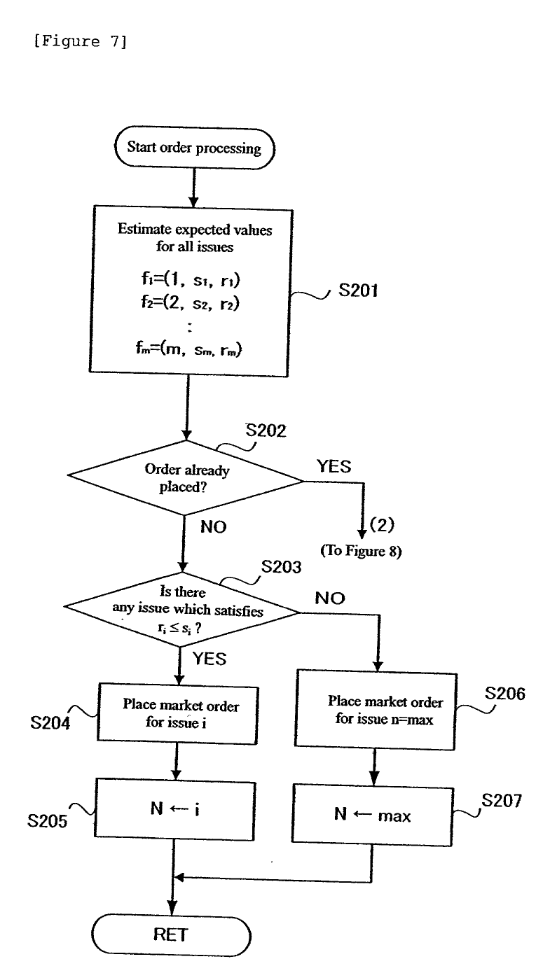

FIG. 8 is a flowchart describing, in detail, the order processing shown in FIG. 6; and

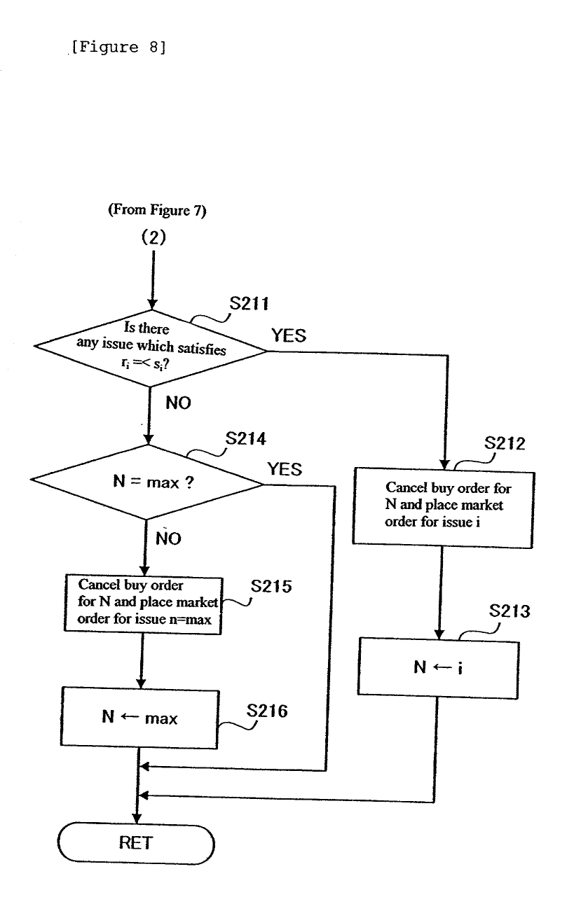

FIG. 9 is a flowchart describing, in detail, the closed option processing performed in FIG. 6.

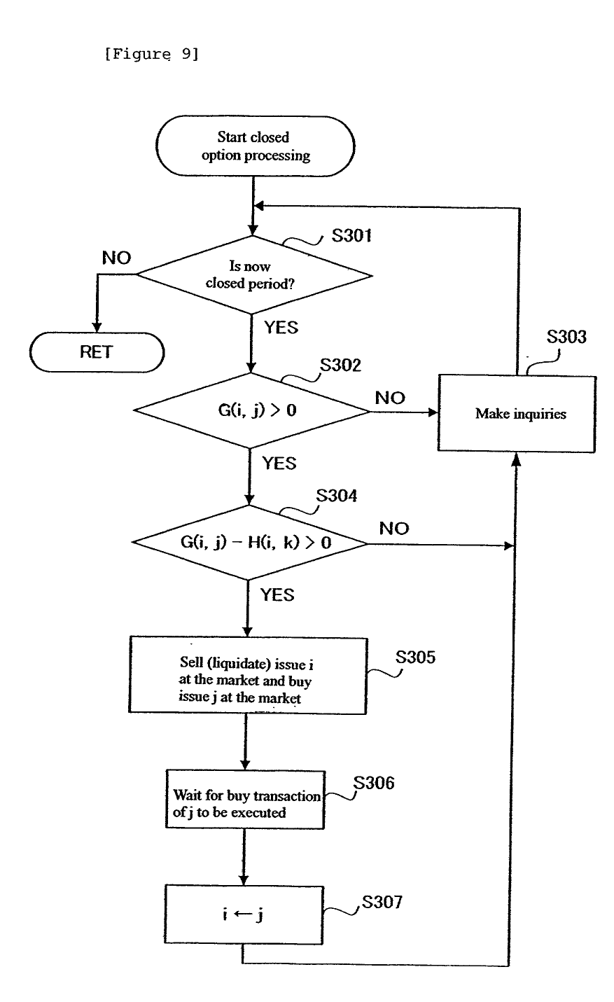

1) A securities trading system comprising a customer's computer connected to a network and a brokerage firm's computer system which is connected to the network and processes securities trading orders from the customer's computer,
wherein said brokerage firm's computer system provides information of a group order entry screen for entering an order covering multiple issues and respective limit prices of the issues specified as a group, to said customer's computer through said network, and
said customer's computer outputs a group order covering a group of issues for which respective limit prices are specified, through said network, based on said group order entry screen information provided by said brokerage firm's computer system.

2) The securities trading system according to claim 1, wherein said group order entry screen provided by said brokerage firm's computer system includes specification of closed option processing that permits to buy and sell issues in the group freely by specifying a period during which placement of a liquidation order from the customer is prohibited.

3) The securities trading system according to claim 1, wherein said brokerage firm's computer system outputs information on order execution for one of the issues of said group order put in by said customer's computer.

4) The securities trading system according to claim 1, further comprising a securities exchange's computer connected to said brokerage firm's computer system through a predetermined line,
wherein said brokerage firm's computer system outputs buy/sell orders for a particular issue in said group order to said securities exchange's computer through said line.

5) A computer system for processing securities trading orders from a customer, comprising:
a group order receiving unit for receiving a group order for a group of issues for which respective limit prices are specified; and
an output unit for outputting information on order execution for one of the issues of said group order received by said group order receiving unit if the trade is executed for that issue at the specified limit price.

6) The computer system according to claim 5, further comprising a limit order output unit for outputting a limit order for a particular issue among said issues of said group order received by said group order receiving unit.

7) The computer system according to claim 5,
wherein said group order received by said group order receiving unit includes specification of closed option processing which defines a closed period, and
said output unit outputs information on order execution for one of the issues for which buy/sell transactions have been executed by said closed option processing.

8) A computer system comprising:
a group order screen providing unit for providing, to a customer's computer, a group order screen for the customer to put in a buy/sell order by specifying a group of issues and respective limit prices of the issues;
an order receiving unit for receiving a group order from the customer based on said group order screen provided by said group order screen providing unit, and
a buy/sell order output unit for outputting a market order or limit order for each of the given issues of said group order received from said order receiving unit.

9) The computer system according to claim 8, wherein said group order screen provided by said group order screen providing unit includes specification of closed option processing that permits to get profit margins by specifying a closed period during which placement of a liquidation order from the customer is prohibited.

10) The computer system according to claim 8, wherein said buy/sell order output unit outputs said market order based on an estimation function for estimating the expected values for the limit prices being realized in the future.

11) A buy/sell order placement method for placing buy/sell orders for securities with a brokerage firm, wherein said method:
defines a group including multiple issues with specified respective limit prices; and
ensures that the order for one of the issues will be placed by said brokerage firm if the limit price for one or more issues in said group is satisfied on the securities market.

12) The buy/sell order placement method according to claim 11, wherein said group is defined by specifying multiple issues for a group order on an order entry screen provided to a customer's computer through a network.

13) The buy/sell order placement method according to claim 11, wherein the buy/sell order for a particular issue in said group is placed at the discretion of said brokerage firm.

14) A buy/sell order placement method for placing buy/sell orders for securities with a brokerage firm through a network, said method comprising the steps of:
sending, through said network, group order entry screen information for specifying multiple issues and respective limit prices of the issues as a group; and
receiving, through said network, order information including multiple issues, limit prices of the issues, and a validity period of the group order entered by a customer based on said group order entry screen information.

15) A buy/sell order processing method, said method comprising the steps of:
receiving a group order including multiple issues and specified respective limit prices of the issues as a group;
estimating expected values of all the issues of said group order received; and
putting in a limit order for the issue with the highest expected value.

16) The buy/sell order processing method according to claim 15, said method further comprising the steps of:
determining whether market prices satisfy the limit prices for the issues of said group; and
putting in market orders for the issues for which the market prices satisfy the limit prices.

17) A buy/sell order processing method, said method comprising the steps of:
accepting specification of closed option processing that permits to get profit margins by specifying a closed period during which placement of a liquidation order from the customer is prohibited along with a group order including multiple issues and specified respective limit prices of the issues as a group;
determining whether the present profit is estimated to be larger than future profit according to a profit estimation function; and
executing the trade of the issues which are estimated to give larger profits at present than in the future.

18) The buy/sell order processing method according to claim 17, wherein said method sells at the market the issue which has already been bought, and buys at the market one of the other issues that will maximize profit.

19) A computer program product comprising a computer usable medium having computer readable program code means embodied in said medium, for implementing in a computer said computer program product comprising:
a computer readable program code means for causing the computer to receive, through a network, a group order consisting of multiple issues and their limit prices specified on an order entry screen; and
a computer readable program code means for causing the computer to decide on the issue for which a buy/sell order should be placed out of the issues of said group, based on said group order received through said network.

20) The program according to claim 19, wherein the program code means for causing the computer to indicate the issue causes the computer decides on the issue that will maximize the value of a profit estimation function at present if the present profit is estimated to be larger than future profit according to the profit estimation function.

21) The program according to claim 19, further comprising a computer readable program code means for causing the computer to sell at the market the issue which has already been bought, and buy at the market one of the other issues that will maximize profit if the present profit is estimated to be larger than future profit according to a profit estimation function, in a closed period during which placement of a liquidation order from the customer is prohibited.
